(19) United States
(12) Patent Application Publication
(10) Pub. No.: US 2010/0306451 A1
(43) Pub. Date: Dec. 2, 2010

(54) ARCHITECTURE FOR NAND FLASH CONSTRAINT ENFORCEMENT

(76) Inventor: Joshua Johnson, Rochester, MN (US)

Correspondence Address: IP Legal Services, 1500 East Lancaster Avenue, Suite 200, P.O. Box 1027, Paoli, PA, 19301, US

(21) Appl. No.: 12/475,710

(22) Filed: Jun. 1, 2009

(51) Int. Cl. G06F 12/00; G06F 12/02

(52) U.S. Cl. 711/103; 711/E12.001; 711/E12.008

(57) ABSTRACT

Described embodiments provide for constraint checking for constraints imposed on NAND flash devices. An exemplary implementation of a computing environment comprises at least one NAND data storage device. In the illustrative implementation, the data processing and storage management paradigm allows for the storage of data according using a selected constraint enforcement algorithm. A NAND data storage constraint checking module can be operable to enforce one or more selected device constraints with one or more co-operating components to the NAND data store.

### BACKGROUND

Recent technological trends in flash media have made it an attractive alternative for data storage in a wide spectrum of computing devices such as PDA's, mobile phones, embedded sensors, MP3 players, etc. The success of flash media for these devices is due mainly to its superior characteristics such as smaller size, lighter weight, better shock resistance, lower power consumption, less noise, and faster read performance than disk drives. While flash-memory has been the primary storage media for embedded devices from the very beginning, there is an increasing trend that flash memory will infiltrate the personal computer market segment. As its capacity increases and price drops, flash media can overcome adoption as compared with lower-end, lower-capacity magnetic disk drives.

NAND devices are generally manufactured and produced to be as simple and inexpensive as possible. Because of the low-cost demands for NAND flash, there is typically no resource applied to validating whether or not a command presented to the NAND flash is correct or in the best interest of the data contained in the flash part itself before it is processed; stated bluntly they are “dumb” devices. This poses a very real problem for storage devices that must meet certain expectations with respect to data protection.

The fabrication processes for NAND devices has traditionally not allowed for types of constructs that would make it easy to add embedded processing/checking power to the NAND device, thus there are only the simplest of state machines incorporated for processing NAND commands on the NAND device. Thus, it is up to the NAND controller to ensure the data integrity of the user data stored on the part. NAND controllers, however, are not “fool proof” given that errors in the NAND memory, firmware, or other components, can cause an otherwise correct controller command sequence to become an erroneous sequence. This erroneous sequence can cause the loss of user data.

Further, NAND flash imposes restrictions on usage as described in the NAND flash data sheets or application notes that are generally not enforced by the NAND device itself. In operation, a host cooperating with, or managing the NAND flash device can cause irreversible harm to the data contained in the flash or possibly to the flash device itself if the host fails to properly obey the constraints of the NAND flash device.

It is appreciated from the foregoing that there exists a need for systems and methods to overcome the shortcomings of existing NAND architectures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The subject matter described herein allows for systems and methods to for data processing and storage management. In an illustrative implementation an exemplary computing environment comprises at least one NAND data store operative to store one or more data elements, a NAND data storage and management controller, a NAND data store constraint checking module, and at least one instruction set to instruct the NAND data processing and storage controller and/or the NAND data store constraint checking module to process and/or store data according to a selected data processing and storage management paradigm. In the illustrative implementation, the data processing and storage management paradigm allows for the storage of data according to a selected constraint enforcement algorithm.

In the illustrative implementation, the exemplary NAND data storage constraint checking module can be operable to enforce one or more selected device constraints with one or more cooperating components to the NAND data store. In the illustrative implementation, the NAND data storage constraint checking module can comprise one or more logic gates and firmware algorithms that are operably independent from the NAND data storage and management controller. In an illustrative operation, the exemplary NAND data storage constraint checking module can perform one more constraint checks for one or more constraints of the NAND data store and cooperating with the NAND data storage and management controller to applying one or more selected constraints on a requested data storage/management operation to be performed on the NAND data store.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a block diagram of one example of an exemplary computing environment operating a NAND data store.

FIG. 2 is a block diagram of one example of an exemplary computing environment deploying a NAND data store performing one or more constraint checking operations in accordance with the herein described systems and methods.

FIG. 3 is a block diagram of an exemplary NAND data store architecture in accordance with the herein described systems and methods.

FIG. 4 is a block diagram of exemplary other illustrative deployments of a NAND data store constraint checking module in illustrative exemplary computing environments in accordance with the herein described systems and methods.

FIG. 5 is a flow diagram of exemplary processing performed when checking constraints of a NAND data store in accordance with the herein described systems and methods.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

### Flash Storage Media Overview:

Flash storage is generally available in three major forms: flash chips, flash cards, and solid state disk (SSD) drives. Flash chips are primarily of two types: NOR and NAND. While NOR flash has faster and simpler access procedures, its storage capacity is lower and hence it is used primarily for program storage. NAND flash offers significantly higher storage capacity (e.g., currently 4 GB in a single chip) and is more suitable for storing large amounts of data. The key properties of NAND flash that directly influence storage design are related to the method in which the media can be read or written.

With flash media, all read and write operations happen at page granularity (or for some chips down to ⅛th of a page granularity), where a page is typically 512-4096 bytes. Pages are organized into blocks, typically of 32-128 pages. A page can be written only after erasing the entire block to which the page belongs. However, once a block is erased, all the pages in the block can be written once with no further erasing. Page write cost (ignoring block erase) is typically higher than read, and the block erase requirement makes some writes even more expensive. A block wears out after 10,000 to 100,000 repeated writes, and so the write load should be spread out evenly across the chip. Because there is no mechanical latency involved, random read/write is as fast as sequential read/write (assuming the writes are for erased pages).

Flash cards such as compact flash (CF) cards, secure digital (SD) cards, mini SD cards, micro SD cards and USB sticks provide a disk-like ATA bus interface on top of flash chips. The interface is provided through a Flash Translation Layer (FTL), which emulates disk-like in-place update for a (logical) address L by writing the new data to a different physical location P, maintaining a mapping between each logical address (L) and its current physical address (P), and marking the old data as dirty for later garbage collection.

Thus, although FTL enables disk-based applications to use flash without any modification, it needs to internally deal with flash characteristics (e.g., erasing an entire block before writing to a page).

SSD drives are high capacity (512 GB SSD devices are now available) flash packages that use multiple flash chips in parallel to improve read/write throughput. Like flash cards, they use an FTL, and hence suffer from the same performance problems for random writes. Further, write operations often consumes more energy than erase because the duration that power is applied while writing a bit is extended in order to ensure the bit is written.

### Data Storage and Management Features Deployed on Flash Media:

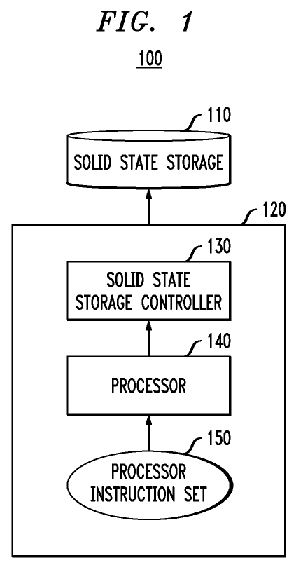

FIG. 1 describes an exemplary computing environment 100 operable to control and manage data storage on solid state storage (e.g., flash media). As is shown, in an illustrative implementation, exemplary computing environment 100 comprises computer environment 120 and solid state storage device 110. Further, as is shown, computer environment comprises solid storage device controller 130, processor 140, and processor instruction set 150.

In an illustrative operation, computing environment 100 can process data for storage and management on solid state storage device 110. In the illustrative operation, processor 140 of computer environment 120 can process data for storage and management on solid state storage device 110 by executing one or more instructions from processor instruction set 150 allowing for the storage and/or management data on solid state storage device 110 through solid state storage controller 130. Operatively, solid state storage controller 130 directed by processor 140 can store and/or manage data on solid state storage device 110 according to one or more data storage principles applicable to the storage and/or management of data on solid state storage devices.

In an illustrative implementation, exemplary data storage principles include, but are not limited to, (i) deleting items in batch and (ii) clustering items to delete together in as few blocks as possible. Stated differently, deleting data in a solid state storage devices (e.g., flash media) generally requires a block erase operation. That is, before erasing a block, valid data in the block needs to be copied to some other location, which requires reading and writing all the valid data. The amortized cost of deleting an item can be made orders of magnitude smaller by deleting multiple items with a single erase operation, such as by clustering data that will be deleted together in the same block.

A second exemplary principle considers updating data already written to flash media. Stated differently, flash media does not allow for updating data in place. Another exemplary principle considers allocating and de-allocating storage space in granularity of blocks. Possible choices for an allocation/de-allocation size can include: (i) sub-page granularity, where fractions of a single flash page are allocated independently (i.e., the same flash page can contain multiple independent data units), (ii) page granularity, where each entire page is allocated independently, and (iii) block granularity, where each entire flash block is allocated independently.

Another solid state storage operating principle considers avoiding random writes in flash media. Generally, flash media is an electronic device and thus has no mechanically moving parts like disk heads in a magnetic disk drive. Therefore, a raw flash memory chip can provide similar sequential and random access speed. However, flash media generally provide poor random write performance.

It is appreciated that, although solid state storage device 110 is shown to be independent of computer environment 120, such description is merely illustrative as the inventive concepts described herein also are applicable to a computing environment including a solid state storage device/component within the computer environment as well.

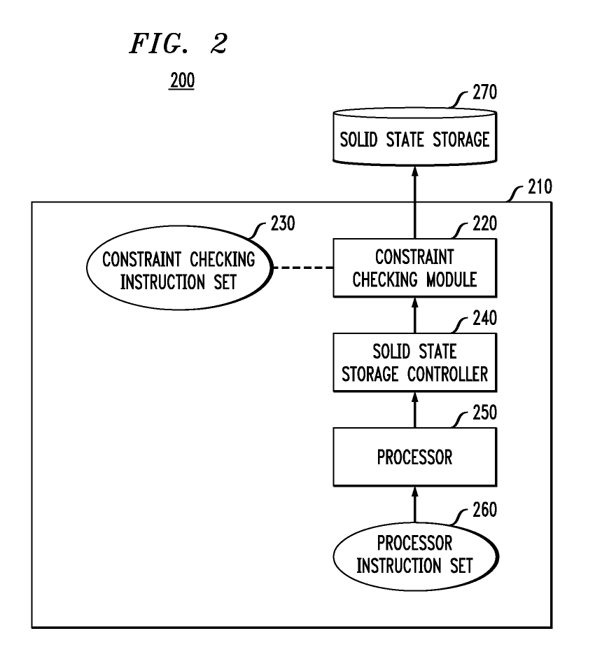

FIG. 2 describes exemplary computing environment 200 operable to control and manage data storage on one or more solid state storage devices (e.g., flash media). As is shown in FIG. 2, in an illustrative implementation, an exemplary computing environment comprises computer environment 210 and solid state storage device 270. Further, as is shown, computer environment 210 comprises processor 250, processor instruction set 260, solid state storage controller 240, constraint checking module 220, and constraint checking instruction set 230. In the illustrative implementation, processor 250, solid state storage controller 240, constraint checking module 220, and solid state storage device 270 are electronically coupled allowing for the communication of various data and/or instructions for storage and/or execution.

In an illustrative operation, computing environment 200 can process data for storage and management on solid state storage device 270. In the illustrative operation, processor 250 of computer environment 210 can process data for storage and management on solid state storage device 270 by executing one or more instructions from processor instruction set 260 allowing for the storage and/or management data on solid state storage device 270 through solid state storage controller 240, constraint checking module 220 operating according to a selected constraint checking paradigm described by one or more constraint checking instructs provided by constraint checking instructions et 230. Operatively, solid state storage controller 240 directed by processor 250 can store and/or manage data on solid state storage device 270 according to one or more constraint driven data storage principles applicable to the storage and/or management of data on solid state storage devices as illustratively provided by constraint checking module 220 operating according to one or more instructions provided by constraint checking instruction set 230.

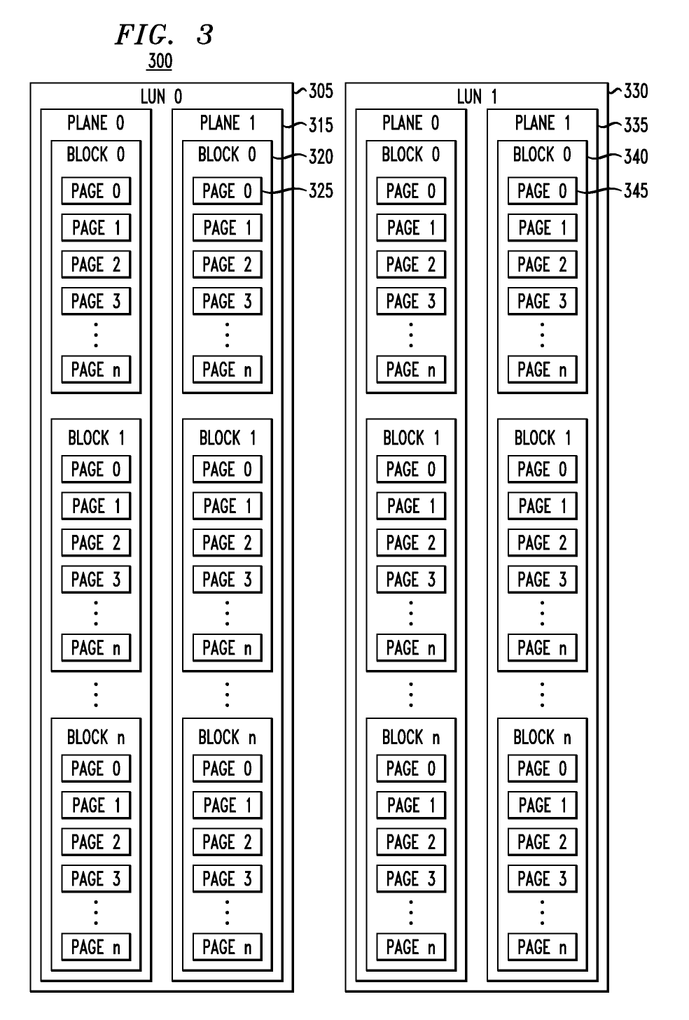

FIG. 3 illustratively describes a typical NAND organization as might be employed with exemplary embodiments of the present invention. As is shown in FIG. 3, exemplary NAND storage device 300 comprises one or more logical unit numbers (LUN) 305 and 330 operating on one or more planes 315 and 335. Further, each LUN can comprise one or more blocks 320 and 340, where each block can comprise one or more pages 325 and 345. Operationally and, by convention, a NAND page can be considered to be the smallest unit to which data can be written. Further, by convention, NAND pages can be partially programmed, but with contemplated practices a NAND page can be constrained to receive one write, rendering such page static until it is erased. Accordingly, NAND blocks can be considered to be the smallest unit that can be erased at once. By way of example, pages contained in the block can all be are erased at once such that data is not able to be retrieved after the erase has occurred. A further restriction that applies to exemplary NAND device 300 is that the pages are required to be programmed in a given order, such as an order where page 0 is first programmed, followed by page 1, followed by page 2, and so on.

In addition to rules relating to how a NAND device may be programmed and erased, by convention, a number of restrictions and constraints exist regarding how commands can be issued when there are multiple LUN's as well as when there are multiple planes involved.

In an illustrative implementation, the policy enforcement can take the form of logic gates, firmware algorithms, or both (e.g., constraint checking module 220 of FIG. 2). In the illustrative implementation, the policy enforcement module can be independent from the controller's primary computing in such a way that an error in the primary portion of the logic does not cause an error when performing data storage and/or management operations on the NAND storage device 300.

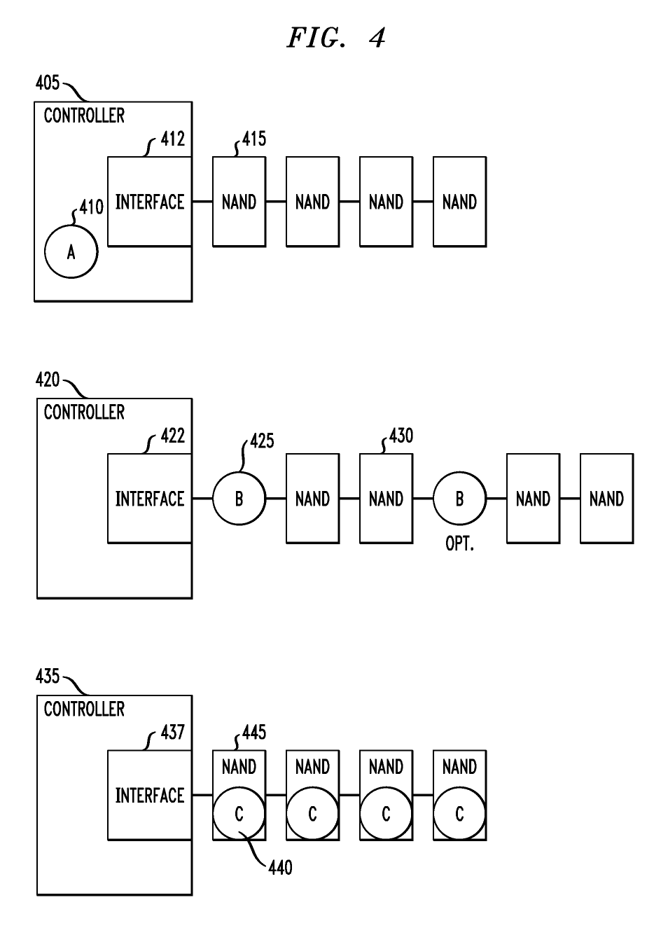

FIG. 4 shows exemplary illustrative implementations of NAND data storage environments having one or more constraint checking components operable to enforce a selected constraint policy. As is shown in FIG. 4, a first exemplary illustrative NAND data storage environment can comprise NAND controller 405, NAND constraint checking module A 410 and NAND storage elements 415. In this illustrative implementation, NAND constraint checking module A410 can be located on the same die or some package as the controller. In an illustrative operation, commands can be processed before they are transmitted from NAND controller's interface 412 to NAND storage elements 430.

In another illustrative implementation, an exemplary NAND data storage environment can comprise a NAND controller 420, NAND constraint checking module B425, and NAND storage elements 430. In this illustrative implementation, the NAND constraint checking module B425 can be located in-line on the NAND interface bus 422. Operatively, this illustrative architecture can be compatible with multiple NAND controllers. In the illustrative implementation, NAND constraint checking module 425 can cooperate with signal processing and/or bus transceiver/bus conversion logic components.

As is shown in FIG. 4, in another illustrative implementation, an exemplary NAND data storage environment can comprise NAND controller 435, NAND constraint checking module 440, and NAND storage elements 445. In the illustrative implementation, NAND constraint checking module 440 can reside in the same electronics package as NAND storage elements 445. Illustratively, this illustrative architecture can allow for direct scaling of the enforcement as the number of NAND packages increases. Additionally, in this illustrative implementation, power and performance benefits can be realized given the physical proximity of the NAND constraint checking module 440 to the NAND storage elements 445.

In an illustrative operation, NAND constraint checking modules 410, 425, or 440 can be operable to independently verify that an NAND data storage/management operation is valid and allowable so that other types of operation such as data deletion or corruption can be eliminated. A few examples of constraints checks that can be performed include but are not limited to, (i) assure valid data has been removed or relocated from a block before it is erased; (ii) prevent a write to the wrong empty page, or out of order empty page; (iii) prevent a write to a page that has already been written; (iv) do not program a page if its partial program count would be exceeded; (v) ensure the data pipeline of the NAND device has been flushed; and (vi) do not write a page if its recommended program/erase count is exceeded.

In the illustrative implementations, if the constraint checking is robust enough, it may be able to maintain the integrity of an exemplary NAND device mapping, or maintain an independent copy of the mappings. In the illustrative implementations, one or more maps that can be available include logical to physical (L2P) sector map, and its' inverse, the physical to logical (P2L) sector map. In an illustrative operation, if the L2P map becomes corrupted, then the P2L mapping information can be consulted to rebuild it. Further, if both maps somehow become corrupt or incomplete, the NAND device can be operable to return incorrect data, and data loss can occur. In the illustrative implementations, data can be often moved from one location to another by a process called “garbage collection” due to NAND flash program and erase constraints.

In an illustrative operation, a block can be selected with a low number of valid data pages and can be operable to relocate the valid data pages such that the selected block may be erased and used to receive new write data. A convention of NAND storage devices can result in having multiple historical copies of the same logical sector on a device rendering it difficult to determine which data is the most recent version of the data being stored. Illustratively, an intact map and correct execution of commands can be utilized to prevent the NAND device from returning old data. However, if the sectors are consulted to build a map after map corruption, and there are multiple copies of the sector on the media, it can be difficult to ensure that the map is correct. In an illustrative operation, redundant, independent copies of the maps can be maintained to ensure that data does not become “misplaced”. In an illustrative operation, NAND constraint checking modules 410, 425, or 440 can be operable to send known invalid command sequences from the controller such that acceptance or rejection of the invalid sequence and the presence of data corruption can be checked by the exemplary NAND constraint checking modules 410, 425, or 440.

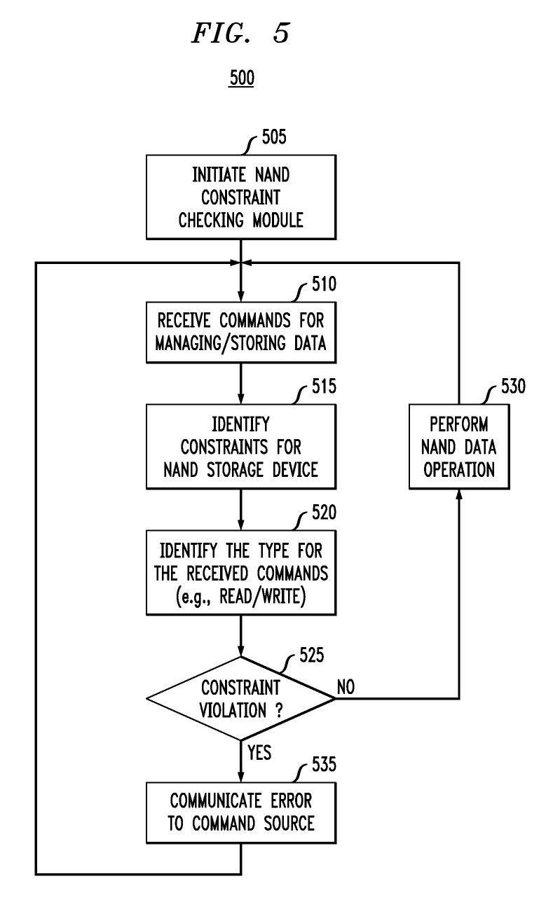

FIG. 5 shows exemplary processing 500 performed when undertaking constraint checking on a NAND data storage device. As is shown, processing begins at block 505 where the NAND constraint checking module is initiated. Processing then proceeds to block 510 where one or more commands for managing/storing data are provided by a cooperating NAND device component (e.g., NAND controller). The constraints for the NAND storage device are then identified at block 515. The received commands are then processed at block 520 to determine the type for the received commands (e.g., whether the received commands are read type or write type commands). At block 525, a check is made to determine if a constraint violation occurred for one or more of the received commands (e.g., using the identified command type and identified constraint violation).

If the check at block 525 indicates that a constraint violation occurred, process proceeds to block 535 where the error is communicated to the command source. From there, processing returns to block 510 and continues from there. However, if the check at block 525 indicates that the received command, when processed, does not result in a constraint violation, processing proceeds to block 530 where the NAND operation is performed. From block 530, the processing 500 returns to block 510.

Reference herein to “as illustrative implementation”, “one embodiment”, or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

What is claimed is:

1. An apparatus performing constraint checking in an NAND storage device comprising:
one or more NAND data storage elements;
a NAND constraint checking module operable to process one or more commands for the storage and/or management of data on the one or more NAND data storage elements; and
an instruction set comprising one or more instructions to instruct the NAND constraint checking module to apply one or more constraints on the processed commands according to a selected NAND constraint checking paradigm,
wherein the NAND constraint checking paradigm comprises at least one instruction to process one or more commands received from a cooperating NAND controller.

2. The apparatus as recited in claim 1, wherein the NAND constraint checking module comprises one or more logic components cooperating with a micro-processor based electronic environment to process one or more commands for the storage and/or management of data.

3. The apparatus as recited in claim 2, wherein the NAND constraint checking module executes a selected constraint checking algorithm executable on the NAND storage device.

4. The apparatus as recited in claim 1, wherein the NAND constraint checking module is co-located with the one or more NAND storage elements.

5. The apparatus as recited in claim 1, wherein the NAND constraint checking module is co-located with the NAND controller.

6. The apparatus as recited in claim 1, wherein the NAND constraint checking module is operatively located between the one or more NAND storage elements and the NAND controller.

7. The apparatus as recited in claim 1, wherein one or more commands are received by the NAND controller from a cooperating micro-processor based electronic environment for the storage and/or management of data.

8. The apparatus as recited in claim 7, wherein the NAND one or more constraints are selected for application based on one or more operational characteristics of the NAND device.

9. A method to perform constraint checking for a NAND storage device comprising:
receiving one or more commands to store and/or manage data on the NAND storage device by a NAND constraint checking module;
identifying one or more constraints of the NAND storage device;
processing the one or more received commands in context of the identified one or more constraints; and
performing a constraint check violation to determine if the one or more received commands result in a constraint violation.
absent a constraint violation, performing an operation on the NAND storage device to retrieve and/or delete data in accordance with the one or more received commands.

10. The method as recited in claim 9, further comprising communicating an error to the source of the one or more received commands.

11. The method as recited in claim 9, further comprising initiating the NAND constraint checking module to process one or more selected constraints.

12. The method as recited in claim 11, further comprising selecting the one or more constraints according to one or more selected operational characteristics of the NAND storage device.

13. The method as recited in claim 9, further comprising receiving one or more commands for the storage and/or management of data by a NAND controller from one or more components of a micro-processor based electronic environment.

14. The method as recited in claim 13, further comprising processing the one or more received commands by the NAND constraint checking module.

15. The method as recited in claim 14, further comprising performing a constraint check violation on the one or more received commands.

16. The method as recited in claim 15, further comprising communicating an error to the source of the one or more received commands upon the occurrence of a constraint check violation.

17. The method as recited in claim 16, further comprising performing an operation on one or more NAND data storage elements of the NAND storage device.

18. The method as recited in claim 9, further comprising performing an operation on one or more NAND data storage elements of the NAND storage device.

19. The method as recited in claim 13, further comprising performing a constraint check violation for one or more constraints comprising,
assuring data has been removed or relocated from a block before it is erased,
preventing a write to an incorrect empty page, or out of order empty page,
preventing a write to a page that has already been written
preventing the programming of a page if its partial program count can be exceeded,
ensuring the data pipeline of the NAND device has been flushed, and
preventing a write to a page if its recommended program/erase count is exceeded.

20. A machine-readable medium, having encoded thereon program code, wherein, when the program code is executed by a machine, the machine implements a method for performing constraint checks on a NAND storage device, comprising:
receiving one or more commands to store and/or manage data on the NAND storage device by a NAND constraint checking module;
identifying one or more constraints of the NAND storage device;
processing the one or more received commands in context of the identified one or more constraints; and
performing a constraint check violation to determine if the one or more received commands result in a constraint violation.
absent a constraint violation, performing an operation on the NAND storage device to retrieve and/or delete data in accordance with the one or more received commands.
